(19) United States
(12) Patent Application Publication
(10) Pub. No.: US 2014/0153917 A1
(43) Pub. Date: Jun. 5, 2014

(54) CAMERA MODULE WITH PRINTED CIRCUIT BOARD AND LENS HOLDER BONDED TO EACH OTHER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: TANG-HONG ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/961,695

(22) Filed: Aug. 7, 2013

(30) Foreign Application Priority Data
Nov. 30, 2012 (CN) 2012105013456

(51) Int. Cl. G03B 17/12

(52) U.S. Cl. CPC G03B 17/12
USPC 396/529

(57) ABSTRACT

A camera module includes a lens holder, a printed circuit board, and an adhesive. The lens holder includes a bottom surface positioned at an image side and an outer sidewall perpendicularly connected to the bottom surface. The lens holder defines a cutout in an intersecting portion between the bottom surface and the outer sidewall. The lens holder is positioned on the printed circuit board and cooperates with the printed circuit board to form a receiving space corresponding to the cutout. The adhesive is applied to the bottom surface and the printed circuit board. Any excess adhesive will collect in the receiving space.

### BACKGROUND

1. Technical Field

The present disclosure relates to camera modules, and particularly to a camera module including a printed circuit board and a lens holder bonded to the printed circuit board using adhesive.

2. Description of Related Art

Camera modules include a lens holder, a lens held in the lens holder, a printed circuit board, and an image sensor positioned on the printed circuit board. The lens holder is also positioned on and bonded to the printed circuit board by adhesive, and covers the image sensor such that the lens is aligned with the image sensor. To ensure bonding quality, the adhesive may be excessively applied and can spread over the printed circuit board, contaminating the printed circuit board.

Therefore, it is desirable to provide a camera module that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric view of a camera module, according to an embodiment.

FIG. 2 is a cross-sectional view taken along a line II-II of FIG. 1.

FIG. 3 is an enlarged view of a portion III of FIG. 2.

FIG. 4 is a cross-sectional view of a camera module, according to another embodiment.

### DETAILED DESCRIPTION

Embodiments of the present disclosure will be described with reference to the drawings.

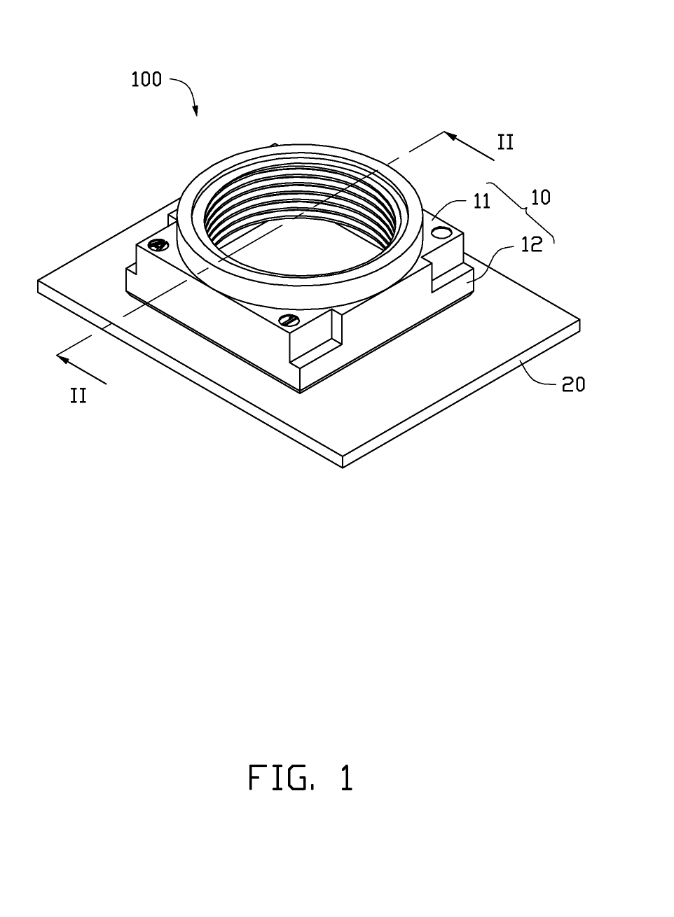

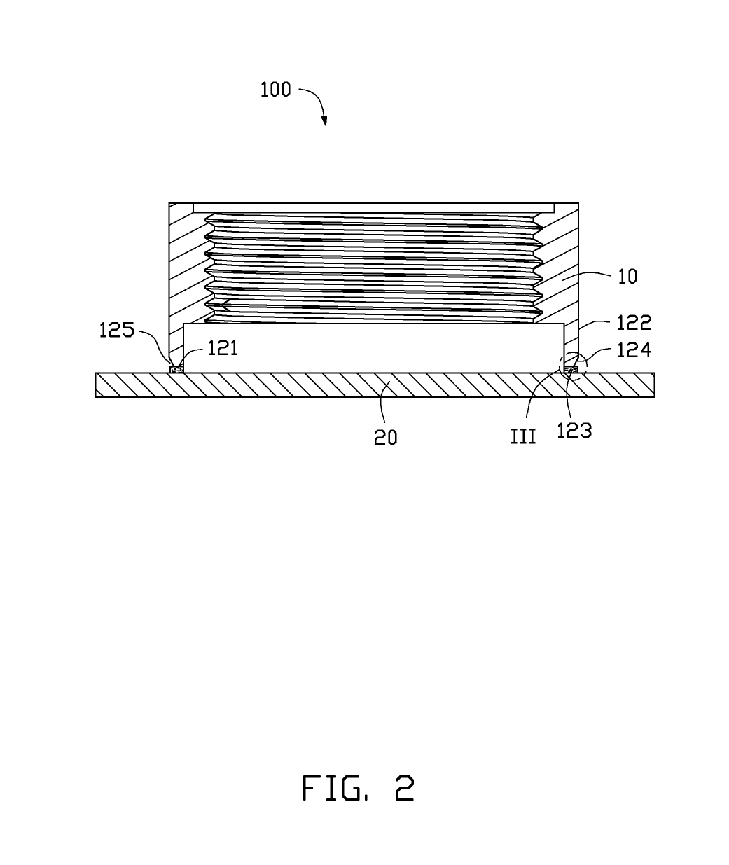

FIGS. 1, 2 show a camera module 100, according to an embodiment. The camera module 100 includes a lens holder 10, a printed circuit board 20, and a layer of adhesive 123.

The lens holder 10 includes a first section 11 and a second section 12. The first section 11 protrudes from and can be integrally formed with the second section 12.

The first section 11 is positioned at an object side of the camera module 100 and is substantially tubular. The first section 11 is internally threaded for engaging with an externally threaded lens (not shown) and, thus, the lens can be held in the first section 11.

The second section 12 is positioned at an image side of the camera module 100 and is a substantially rectangular frame, which corresponds to a shape of an image sensor (not shown) and thus can efficiently accommodate the image sensor. The second section 12 includes a bottom surface 121 and an outer sidewall 122. The bottom surface 121 is opposite to the first section 11 (that is, the bottom surface 121 is positioned at the image side of the camera module 100). The outer sidewall 122 is perpendicularly connected to the bottom surface 121. The second section 12 defines a cutout 124 in an intersecting portion of the bottom surface 121 and the sidewall 122. The cutout 124 continuously extends along a line formed by the intersection of the bottom surface 121 and the sidewall 122. In this embodiment, the cutout 124 has a triangular cross-section.

In assembly, the lens holder 10 is positioned on the printed circuit board 20 and the adhesive 123 is applied between the bottom surface 121 and the printed circuit board 20. Excessive adhesive, if any, can be received in a receiving space 125 cooperatively defined by the lens holder 10 and the printed circuit board 20 and corresponding to the cutout 124. As such, contamination of the printed circuit board 20 by excess adhesive 123 can be avoided.

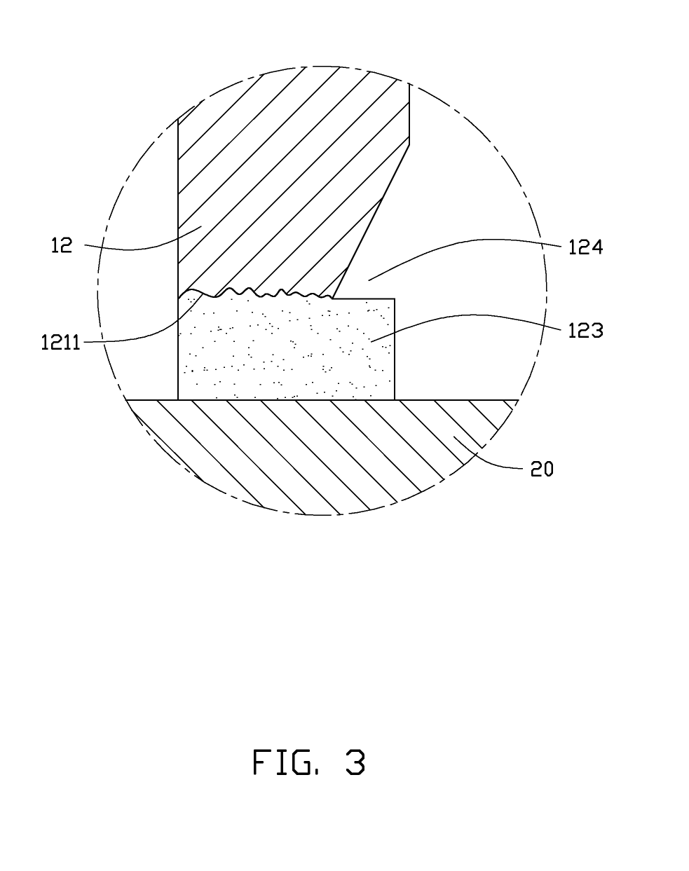

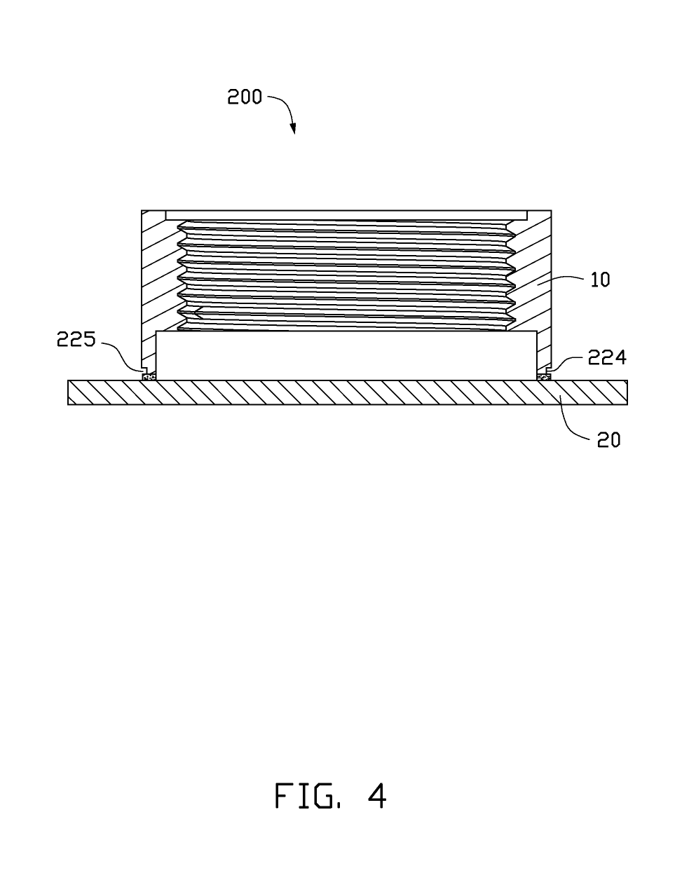

A configuration of the lens holder 10 is not limited to this embodiment. In other embodiments, the second section 12 can be omitted and the first section 11 directly extended to the printed circuit board 12, provided that the second section 12 can efficiently receives the image sensor. The bottom surface 121 can be formed with microstructures 1211, such as micro-recesses, to increase contact surface between the lens holder 10 and the printed circuit board 20 and thus increase bonding force therebetween (see FIG. 3). In another embodiment, the cross-section of the cutout 124 can have other geometric shapes, such as rectangular (see FIG. 4).

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

1. A camera module, comprising:
a lens holder comprising a bottom surface positioned at an image side and an outer sidewall perpendicularly connecting the bottom surface, the lens holder defines a cutout in an intersecting portion of the bottom surface and the outer sidewall;
a printed circuit board, the lens holder positioned on the printed circuit board and cooperating with the printed circuit board to define a receiving space corresponding to the cutout; and
an adhesive applied to the bottom surface and the printed circuit board and is received in the receiving space;
wherein the cutout continuously extends along an intersecting line between the bottom surface and the outer sidewall.

2. The camera module of claim 1, wherein the lens holder comprises a first section and a second section, the first section is tubular and positioned at an object side of the camera module, the second section is rectangular and positioned at the image side, the first section protrudes from the second section, and the bottom surface is formed on the second section and faces away from the first section.

3. The camera module of claim 1, wherein the bottom surface is formed with microstructures.

4. (canceled)

5. The camera module of claim 1, wherein the cutout has a triangular or rectangular cross-section.
